(19) United States
(12) Patent Application Publication
(10) Pub. No.: US 2022/0092563 A1
(43) Pub. Date: Mar. 24, 2022

(54) SYSTEMS AND METHODS FOR COLLECTING ON-TIME RENT PAYMENTS

(71) Applicant: Nasiri, Inc., Redlands, CA (US)

(72) Inventor: Arian Nasiri, Redlands, CA (US)

(21) Appl. No.: 17/026,108

(22) Filed: Sep. 18, 2020

(51) Int. Cl. G06Q 20/10; G06Q 30/06; G06Q 30/02

(52) U.S. Cl. CPC G06Q 20/102; G06Q 30/0216; G06Q 30/0645

(57) ABSTRACT

A system comprising a non-transitory memory storing an executable code and a hardware processor executing the executable code to receive a rental payment input indicating that a renter has paid a rent for a property on a payment date, apportion the rent based on an on-time status of the rent and a renter status of the renter, transmit a rent portion of the apportioned rental payment to a manager, and transmit a rebate portion of the apportioned rental payment to the renter based on the renter status of the renter.

### RELATED APPLICATION(S)

The present application claims the benefit of and priority to a U.S. Provisional Patent Application Ser. No. 62/902,168, filed Sep. 18, 2019, which is hereby incorporated by reference in its entirety into the present application.

### BACKGROUND

Renters typically pay rent to have temporary use of an item or property they do not own, such as a product, a vehicle, or a property. The rental payment is made periodically and is normally due on a certain date with a grace period during which the rent may be paid without incurring a penalty. If the renter fails to pay the rent by the due date, the property owner or property manager may initiate recovery efforts to obtain the rent. These rent recovery efforts cost the owner or manager a great deal of time and energy. A system for guaranteeing on-time rental payments to property owners/manager is needed.

### SUMMARY

The present disclosure is directed to systems and methods for collecting on-time rent payments, substantially as shown in and/or described in connection with at least one of the figures, as set forth more completely in the claims.

In some implementations, the system includes a non-transitory memory storing an executable code and a hardware processor executing the executable code to receive a rental payment input indicating that a renter has paid a rent for a property on a payment date, apportion the rent based on an on-time status of the rent and a renter status of the renter, transmit a rent portion of the apportioned rental payment to a manager, and transmit a rebate portion of the apportioned rental payment to the renter based on the renter status of the renter.

In some implementations, in order to determine the on-time status of the rent, the hardware processor further executes the executable code to compare the payment date with a due date stored in a database and associated with the rent, and identify the rental payment as an on-time status if the payment date is one of a date before the due date and the same date as the due date.

In some implementations, in order to determine the renter status of the renter, the hardware processor further executes the executable code to query the on-time status of a plurality of rental payments made by the renter stored in a database, and assign the renter a renter status based on the plurality of rental payments stored in the database.

In some implementations, the rent portion of the apportioned rental payment is transmitted to the manager on a due date of the rent for the property.

In some implementations, the rent portion of the apportioned rental payment is guaranteed to the manager on a due date of the rent for the property if the manager is a subscriber.

In some implementations, the hardware processor further deposits the rebate portion of the apportioned rental payment in a rebate account.

In some implementations, the rebate account is an interest-bearing account.

In some implementations, the rebate is based on the interest accumulated by the rebate account.

In some implementations, the property is one of a real property and a car.

In some implementations, the property is one of an apartment, a condo, and a house.

### BRIEF DESCRIPTION OF THE DRAWINGS

FIG. 1 shows a diagram of an exemplary system for collecting on-time rent payments, according to one implementation of the present disclosure;

FIG. 2 shows a diagram of an exemplary process for collecting on-time rent payments, according to one implementation of the present disclosure;

FIG. 3 shows a diagram of another exemplary process for collecting on-time rent payments, according to one implementation of the present disclosure;

FIG. 4 shows a flowchart illustrating an exemplary method of collecting on-time rent payments, according to one implementation of the present disclosure;

FIG. 5 shows another flowchart illustrating an exemplary method of collecting on-time rent payments, according to one implementation of the present disclosure; and

FIG. 6 shows another flowchart illustrating an exemplary method of collecting on-time rent payments, according to one implementation of the present disclosure.

### DETAILED DESCRIPTION

The following description contains specific information pertaining to implementations in the present disclosure. The drawings in the present application and their accompanying detailed description are directed to merely exemplary implementations. Unless noted otherwise, like or corresponding elements among the figures may be indicated by like or corresponding reference numerals. Moreover, the drawings and illustrations in the present application are generally not to scale and are not intended to correspond to actual relative dimensions.

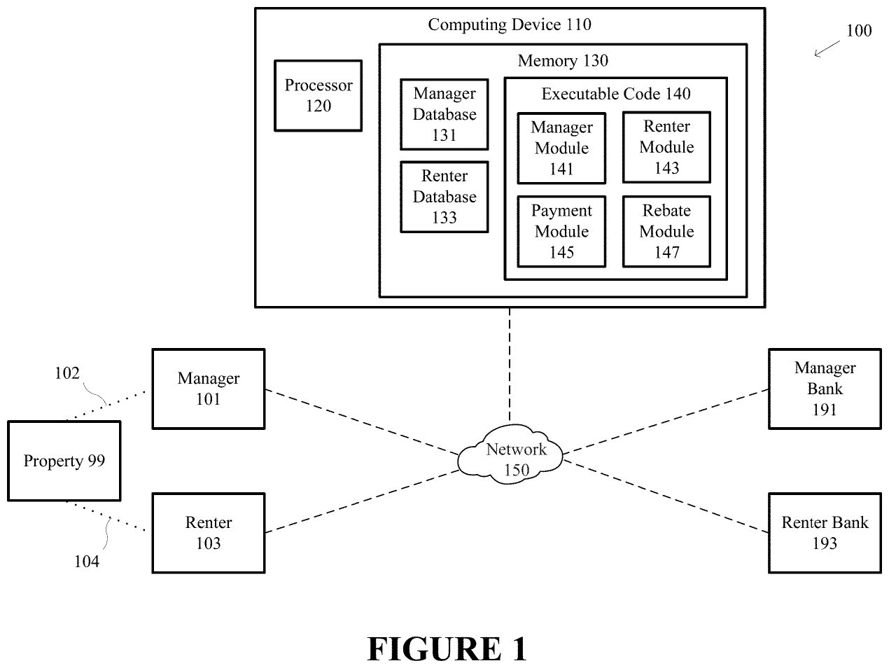

FIG. 1 shows a diagram of an exemplary system for collecting on-time rent payments, according to one implementation of the present disclosure. Diagram 100 shows property 99, manager 101, relationship 102, renter 103, relationship 104, computing device 110, manager bank 191, and renter bank 193. Property 99 is property that is rented by renter 103 and is managed by manager 103. Property 99 may be an item of personal property, such as clothing or jewelry, a tool, such as a power tool, a piece of furniture, such as a bed, a dresser, or a desk, a vehicle, such as a car or truck, or other type of personal property that an individual may rent. Property 99 may be residential property, such as an apartment, a condo, a house, or commercial property, such as an office, a warehouse, a building, or an apartment or condo complex.

Manager 101 may be a property owner, a property management company, an association, a government entity, a private business, a public business, or other entity that collects rent for property. Property rented includes real property, such as residential property or commercial property, personal property, vehicles, or other types of property that can be rented. In some implementations, the property may be an apartment, a condo, a residential home, a mobile home, a recreational vehicle, or other dwelling unit. The relationship between property 99 and manager 101 is shown by relationship 102 indicating that manager 101 manages property 99.

Renter 103 is an individual who rents property 99 from manager 101. Renter 103 may rent property 99 for a period of time, such as a number of hours, a number of days, a number of weeks, a number of months, or a number of years. In some implementations, renter 103 may sign a contract guaranteeing a minimum time period during which to maintain the rental, such as a real estate lease on an apartment, condo, or house. The relationship between property 99 and renter 103 is shown by relationship 104 indicating that renter 103 is renting property 99.

Computing device 110 is a is a computing device, which includes processor 120 and memory 130. Processor 120 is a hardware processor, such as a central processing unit (CPU) used in computing devices. Memory 130 is a non-transitory storage device for storing software for execution by processor 120, and also storing various data and parameters. Memory 130 includes manager database 131, renter database 133, and executable code 140. In some implementations, manager 101 or renter 103 may connect to computing device 110 via network 150. Network 150 may be a computer network, such as the Internet. In some implementations, computing device 110 may connect with manager bank 191 and renter bank 193 via a computer network, such as the Internet.

Manager database 131 is a database stored in memory 130. Manager database 131 may store data may store information, data, and statistics about one or more properties including property 99. Manager database 131 may store information, data, and statistics about one or more managers including manager 101. In some implementations, manager database 101 may associate manager 101 with one or more properties including property 99. Manger database may store information related to manager 101, such as reviews, rankings, the length of employment of manager 101, the duration of time manager 101 has managed property 99. In some implementations, manager database 131 may include a payment date associated with property 99. The payment date may be a date on which manager 101 is to be paid the rent for property 99. In some implementations, the payment date may come before the date on which the rent for property 99 is due from renter 103, on the same date that the rent for property 99 is due from renter 103, or on a date after the date that rent for property 99 is due from renter 103.

Renter database 133 is a database stored in memory 130. Renter database 133 may store data may store information, data, and statistics about one or more properties including property 99. Renter database 133 may store information, data, and statistics about one or more renters including renter 103. Renter database 133 may include a renter profile for renter 103. The renter profile may include demographic information about renter 103 such as age information and income information. The renter profile of renter 103 may associated renter 103 with property 99.

The renter profile in renter database 133 may include a due date on which rent for property 99 is due to be paid by renter 103. In some implementations, the renter profile may include a historical record of payments made by renter 103 for rent of property 99. The historical record may include whether payments were received before the payment was due, on the day the payment was due, or after the day the payment was due. The renter profile of renter 103 may include properties other than property 99. In some implementations, the other properties may be other properties currently rented by renter 103, or they may be other properties previously rented by renter 103.

Executable code 140 is a computer algorithm stored in memory 130 for execution by processor 120 for managing rental payments received from renter 103 and paying rents to manager 101. As shown in FIG. 1, executable code 140 includes manager module 141, renter module 143, payment module 145, and rebate module 147. Manager module 141 is a computer algorithm stored in memory 130 for execution by processor 120 for calculating rent payments and transmitting rent payments to manager 101. In some implementations, manager module 141 may record payments received from renter 103 in manager database 131 or renter database 133. Manager module 141 may refer to manager database 131 and renter database 133 to associate manager 101 with property 99 and renter 103.

Renter module 143 is a computer algorithm stored in memory 130 for execution by processor 120 for collecting rent from renter 103 and managing and updating the profile of renter 103 in renter database 133. Renter module 143 may receive a rent payment from renter 103. Renter module 143 may determine that a rent payment is an on-time rent payment by comparing the date the rent payment is received with the date the rent payment is due. In some implementations, renter module 143 may determine the on-time status of the rent payment by querying manager database 131 for a due date of the rent for property 99. In some implementations, renter module 143 may include a reminder function to send a notification to renter 103 that a rent payment is due.

Payment module 145 is a computer algorithm stored in memory 130 for execution by processor 120 to process a monthly payment for rent due on property 99. Payment module 145 may receive payments from renter 103. In some implementations, payments may be received from renter 103 via an electronic payment, a wire transfer, a check or money order payment, or other method of making money payments. Electronic payments may include payment by a payment application, such as PayPal®, Venmo®, Zelle®, crypto currencies, such as bitcoin, or other way of making electronic payment.

Payment module 145 may transmit payments to manager 101 and renter 103. In some implementations, payment module 145 transmits a monthly payment to manager 101 for rent due on property 99 on a payment date each month. Payment may be transmitted to a bank account such as manager account 191 or to another payment account, such as an internet-based payment processing account. In some implementations, payment module 145 may transmit payments via an electronic payment, a wire transfer, a check or money order payment, or other method of making money payments. Electronic payments may include payment by a payment application, such as PayPal®, Venmo®, Zelle®, crypto currencies, such as bitcoin, or other way of making electronic payment.

In some implementations, payment module 145 may determine a portion of a rental payment received from renter 103 that is delivered to manager 101 and a portion of the rental payment that is deposited in a rebate account. In some implementations, the portion of the rental payment delivered to manager 101 may increase with the amount of time manager 101 has been in system 101, a number of positive reviews received, a number of properties managed by manager 101 in system 100. Various other criteria may cause the proportion of the rental payment that is distributed to manager 101 to increase or decrease.

Rebate module 147 is a computer algorithm stored in memory 130 for execution by processor 120 to determine a renter rebate for renter 103. In some implementations, the renter rebate may be a monthly rebate. In some implementations, the renter rebate is calculated by a percentage of the rent paid on-time, or by calculating a percentage of the amount deposited into account 191. The renter rebate may be calculated based on the number of on-time payments made by renter 103. The amount of the renter rebate may increase with the number of consecutive on-time payments received.

In some implementations, the renter rebate may be tabulated throughout a rental period and provided to renter 103 after the rental period is over. For example, a rental period may coincide with the term of a tenancy, such as a twelve-month period for a year-long lease. The amount of the renter rebate may be affected by the number of consecutive on-time payments received by renter module 143 from renter 103. In other implementations, renter 103 may have access to the accumulated balance of the rebate at any time during tenancy. In some implementations, the amount of the renter rebate may be negatively impacted by a late payment. For example, a late payment may result in a dollar-amount penalty deducted from the renter rebate or a percentage decrease in the renter rebate. If renter 103 makes a certain number of late payments or a certain percentage of late payments, the renter rebate may drop to zero, and in some situations, renter 103 may pay a penalty. In some implementations, a late payment may be a payment the is not an on-time payment.

In some implementations, manager 101 is a subscriber that has signed up to receive guaranteed on-time rental payments each month. Executable code 140 may transfer rental payments for one or more rented properties to manager 101 on a certain day each month, such as on the first or the month or on the fifth of the month. By subscribing to the service, manager 101 receives a guaranteed payment each month. Manager 101 does not have to expend time or energy to seek payment of rent or seek payment of past-due rent. In exchange for this service, manager 101 discounts the rent received by a rental discount percentage. In some implementations, the rental discount percentage is applied to the rental payment received from renter 103 and the amount of the discount is the amount deposited into account 191.

Manager bank 191 and renter bank 193 are banking institutions. A banking institution may be a local bank, a national bank, a private money lender, or other entity in the business of banking. In some implementations, manager bank 191 and renter bank 193 may be financial institutions licensed to receive deposits and make loans, commercial banks, retail banks, or investment banks. Manager bank 191 and renter bank 193 may be financial institutions managed, regulated, certified, or insured by a state or federal government. In other implementations, manager bank 191 and renter bank 193 may be online entities such as a financial firm that offering cash management accounts to businesses and consumers.

Manager bank 191 and renter bank 193 may be different banks or the same bank. In some implementations, manager bank 191 and renter bank 193 may be the same institution, with manger 101 having an account and renter 103 having a separate account. In other implementations, manager bank 191 and renter bank 193 may be different institutions. Manager bank 191 and renter bank 193 may also provide financial services, such as wealth management, currency exchange, etc. Manager bank 191 and renter bank 193 may be a commercial bank, a retail bank, or an investment bank.

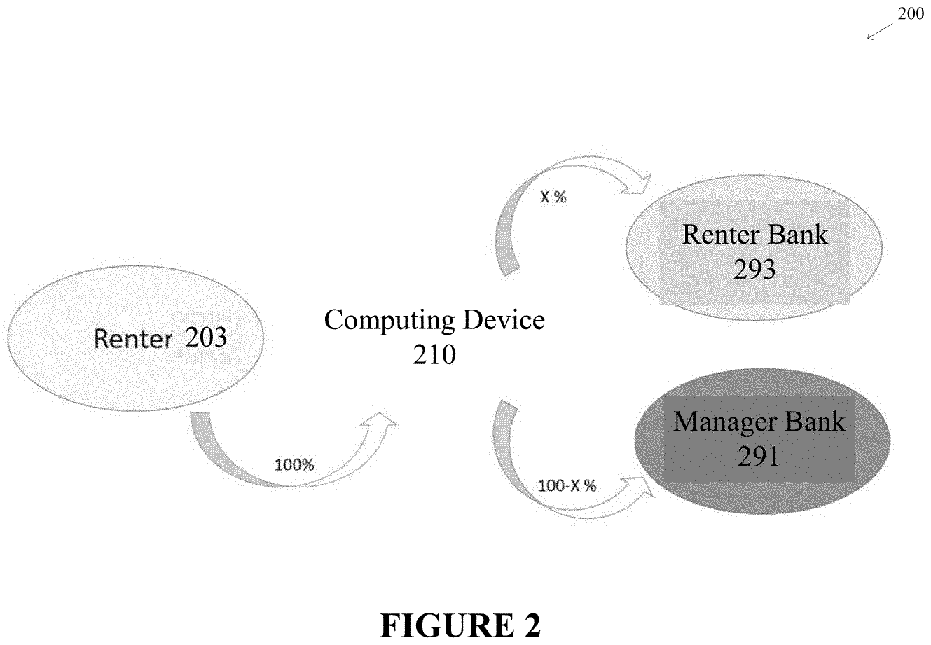

FIG. 2 shows diagram 200 of an exemplary process for collecting on-time rent payments, according to one implementation of the present disclosure. As shown in FIG. 2, the payment system, which may be online based on an online payment platform/website OR offline, permits a percentage (X %) of the rent paid by renter 203 to be transferred to an account at renter bank 293, such as an investment or savings account for the renter with the remainder of the payment (full rent payment(100%)−X %) paid to the manager bank 291.

The rent payment from the renter to the manager may be received by computing device 210 allowing the payment (full rent payment (100%)−x %) to be paid to manager bank 291 by the intermediary entity prior to the rent payment (100% full rent payment) being received by the intermediary entity.

The payment to manager bank 291 (Full rent payment (100%)−X %) from computing device to manager may be guaranteed to be paid on a specific day of the month regardless of if rent payment (100% rent payment) has been received by computing device 210 from renter 203. In some implementations, renter 103 may have access to the accumulated funds in their investment or savings account at all times.

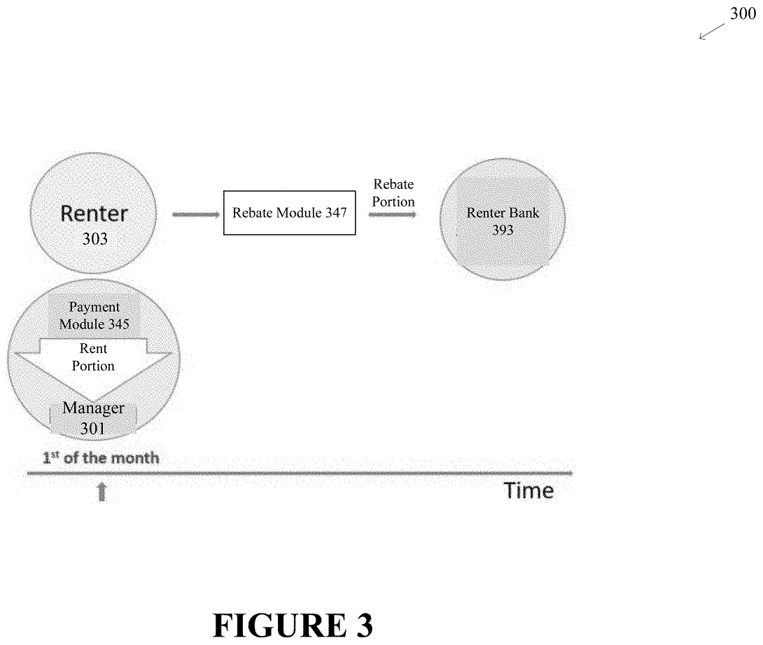

FIG. 3 shows diagram 300 illustrating another exemplary process for collecting on-time rent payments, according to one implementation of the present disclosure. As shown in FIG. 3, a rent portion of a rental payment made by renter 303 is transmitted by payment module 345 to manager 301 on the first of the month. The day on which the payment is transmitted to manager 301 may be any day of the month and the first is used merely for demonstrative purposes. A rebate portion of the rental payment made by renter 303 is transmitted by rebate module 347 to renter bank 393. In some implementations, the rebate portion may be transmitted after the rent portion is transmitted. In some implementations, the rebate portion may remain in renter bank for some minimum amount of time to allow for sufficient appreciation or growth of the balance of the rebate account in renter bank 393.

Renter 303 may have access to the balance of the rebate account in renter bank 393 after the rental payment is made. In other implementations, renter 303 may have delayed access to the balance of the rebate account. As time passes, the balance of the rebate account will increase. In some implementations, as the renter status of renter 303 increases, the portion of the rental payment that is apportioned to the rebate portion may increase, thus incentivizing on-time payment by renter 303. In some implementations, the balance of the rebate account may be used to pay a fee or penalty incurred by a late payment by renter 303. This may allow for renter 303 to not be impacted by a one-off crisis moment and may serve as a disincentive to make late payments.

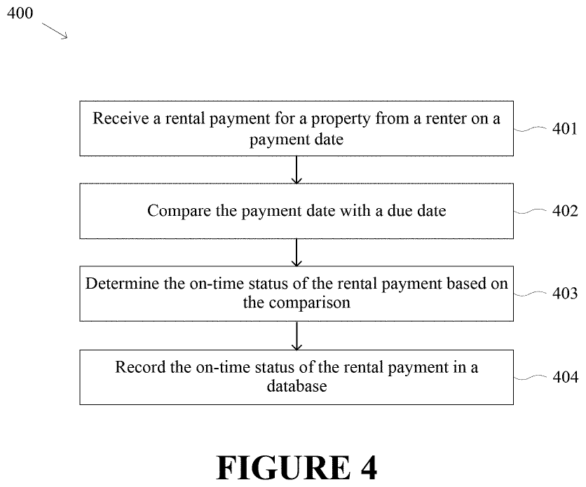

FIG. 4 shows flowchart 400 illustrating an exemplary method of determining the on-time status of a rental payment, according to one implementation of the present disclosure. The method begins at 401, where processor 120 receives a rental payment for property 99 from renter 103 on a payment date. The payment date may be the date on which renter 103 sends the payment, the date on which manager 101 receives the payment, or the date on which the payment is received in manager bank 191. Payment module 145 may record the payment date in manager database 131 or renter database 133.

At 402, processor 120 compares the payment date with a due date. The due date may be due date of the rental payment, such as the first day of the month, or the date on which a grace period for payment has run, such as the fifth of the month. At 403, processor 120 determines the on-time status of the rental payment based on the comparison. In some implementations, payment module 145 may determine a payment sent on or before the due date may is an on-time payment. In some implementations, payment module 145 may determine a payment received by payment module 145 or manager bank 191 on or before the due date is an on-time payment. In some implementations, payment module 145 may compare the payment date with due date stored in manager database 131, renter database 133, or otherwise associated with property 99. At 404, processor 120 records the on-time status of the rental payment in a database, such as renter database 133. In some implementations, renter database 133 may store a record of a plurality of payments made by renter 103 and an on-time status of each payment.

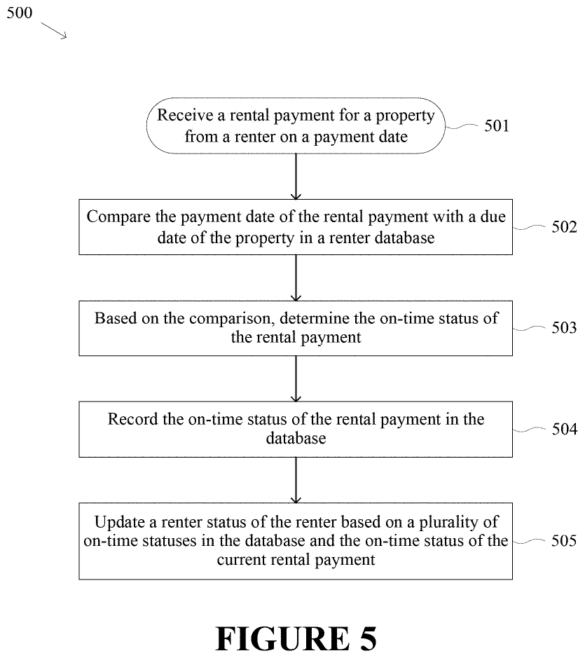

FIG. 5 shows flowchart 500 illustrating an exemplary method of determining a renter status. Executable code 140 may determine the renter status based on the on-time status of the payment. In some implementations, the renter status of renter 103 may be based on a number of on-time payments or based on a percentage of on-time payments made by renter 103 for property 99 and/or additional properties. The on-time payment data associated with renter 99 may be stored in renter database 133. The renter status may be used to determine the amount of the renter rebate. The method begins at 501, where processor 120 receives a rental payment for property 99 from renter 103 on a payment date. At 502, processor 120 compares the payment date of the rental payment with a due date associated with property 99. In some implementations, the due date of the rent for property 99 may be stored in renter database 133.

At 503, processor 120, based on the comparison, determines the on-time status of the rental payment. At 504, processor 120 records the on-time status of the rental payment in the database. At 505, processor 120 updates a renter status of the renter based on a plurality of on-time statuses in the database and the on-time status of the current rental payment.

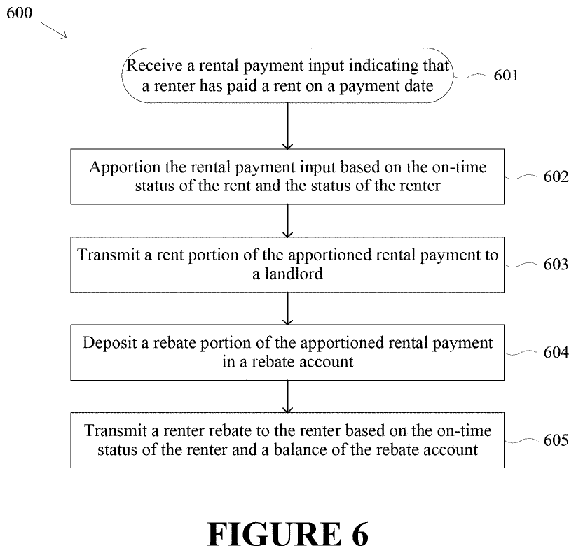

FIG. 6 shows flowchart 600 illustrating an exemplary method of collecting on-time rent payments, according to one implementation of the present disclosure. The method begins at 601, where processor 120 receives a rental payment input indicating that a renter has paid a rent on a payment date. At 602, processor 120 apportions the rental payment input based on the on-time status of the rent and the status of the renter. In some implementations, the apportionment may divide the amount of the rental payment into a rent portion and a rebate portion. In some implementations, rebate module 147 calculates the rebate portion based on the renter status. In some implementations, the rebate portion may be calculated based on a number of on-time payments made or a percentage of on-time payments made. In some implementations, the rebate portion may be increased by a higher number of on-time payments or higher percentage of on-time payments. In some implementations, the renter rebate portion may be reduced by an amount or a percentage based on a number of payments that were not on-time payments.

At 603, processor 120 transmits a rent portion of the apportioned rental payment to a landlord. In some implementations, the rent portion of the apportioned rental payment may be an on-time rental payment to manager 101, wherein the rental payment is a percentage of a full rental amount. In some implementations, the on-time rent portion of the apportioned rental payment may be a discounted rental amount that is less than a full rent amount. By way of non-limiting example, the discounted rent amount may be 99% of the full rent amount, 98% of the full rent amount, 95% of the full rent amount, 90% of the full rent amount, or some other percentage discount of the full rent amount. In some implementations, executable code 140, using hardware processor 120, may calculate the discounted rent amount by multiplying the full rent amount by a renter-specific multiplier. The renter-specific multiplier may be determined by the on-time status of renter 103 or the renter status of renter 103.

At 604, processor 120 deposits a rebate portion of the apportioned rental payment in a rebate account at renter bank 193. The rebate account may be an interest-bearing bank account, such as an interest-bearing checking account or savings account. In some implementations, the rebate account may be an investment account. The interest earned on the amount deposited may affect a rebate given to the renter at the end of a rental term.

At 605, processor 120 transmits a renter rebate to the renter based on the on-time status of the renter and a balance of the rebate account. In some implementations, transmitting the renter rebate may include depositing the apportioned part of the rental payment with renter bank 193.

From the above description, it is manifest that various techniques can be used for implementing the concepts described in the present application without departing from the scope of those concepts. Moreover, while the concepts have been described with specific reference to certain implementations, a person having ordinary skill in the art would recognize that changes can be made in form and detail without departing from the scope of those concepts. As such, the described implementations are to be considered in all respects as illustrative and not restrictive. It should also be understood that the present application is not limited to the particular implementations described above, but many rearrangements, modifications, and substitutions are possible without departing from the scope of the present disclosure.

What is claimed is:

1. A system comprising:
a non-transitory memory storing an executable code; and
a hardware processor executing the executable code to:
receive a rental payment input indicating that a renter has paid a rent for a property on a payment date;
determine an on-time status of the rent;
update a renter status of the renter based on the on-time status of the rent;
apportion the rent based on the on-time status of the rent, a manager criteria of a manager, and the renter status of the renter;
transmit a rent portion of the apportioned rental payment to the manager; and
transmit a rebate portion of the apportioned rental payment to the renter based on the renter status of the renter.

2. The system of claim 1, wherein, to determine the on-time status of the rent, the hardware processor further executes the executable code to:
compare the payment date with a due date stored in a database and associated with the rent; and
identify the rental payment as an on-time status if the payment date is one of a date before the due date and the due date.

3. The system of claim 1, wherein, to determine the renter status of the renter, the hardware processor further executes the executable code to:
query the on-time status of a plurality of rental payments made by the renter stored in a database; and
assign the renter a renter status based on the plurality of rental payments stored in the database.

4. The system of claim 1, wherein the rent portion of the apportioned rental payment is transmitted to the manager on a due date of the rent for the property.

5. The system of claim 1, wherein the rent portion of the apportioned rental payment is guaranteed to the manager on a due date of the rent for the property if the manager is a subscriber.

6. The system of claim 1, wherein the hardware processor further deposits the rebate portion of the apportioned rental payment in a rebate account.

7. The system of claim 6, wherein the rebate account is an interest-bearing account.

8. The system of claim 7, wherein the rebate is based on the interest accumulated by the rebate account.

9. The system of claim 1, wherein the property is one of a real property and a car.

10. The system of claim 9, wherein the property is one of an apartment, a condo, and a house.

11. A method for use with a computing system having a non-transitory memory and a hardware processor, the method comprising:
receiving, using the hardware processor, a rental payment input indicating that a renter has paid a rent for a property on a payment date;
determining, using the hardware processor, an on-time status of the rent;
updating, using the hardware processor, a renter status of the renter based on the on-time status of the rent;
apportioning, using the hardware processor, the rent based on the on-time status of the rent, a manager criteria of a manager, and the renter status of the renter;
transmitting, using the hardware processor, a rent portion of the apportioned rental payment to the manager; and
transmitting, using the hardware processor, a rebate portion of the apportioned rental payment to the renter based on the renter status of the renter.

12. The method of claim 11, wherein, to determine the on-time status of the rent, the method further comprises:
comparing, using the hardware processor, the payment date with a due date stored in a database and associated with the rent; and
identifying, using the hardware processor, the rental payment as an on-time status if the payment date is one of a date before the due date and the due date.

13. The method of claim 11, wherein, to determine the renter status of the renter, the method further comprises:
querying, using the hardware processor, the on-time status of a plurality of rental payments made by the renter stored in a database; and
assigning, using the hardware processor, the renter a renter status based on the plurality of rental payments stored in the database.

14. The method of claim 11, wherein the rent portion of the apportioned rental payment is transmitted to the manager on a due date of the rent for the property.

15. The method of claim 11, wherein the rent portion of the apportioned rental payment is guaranteed to the manager on a due date of the rent for the property if the manager is a subscriber.

16. The method of claim 11, wherein the hardware processor further deposits the rebate portion of the apportioned rental payment in a rebate account.

17. The method of claim 16, wherein the rebate account is an interest-bearing account.

18. The method of claim 17, wherein the rebate is based on the interest accumulated by the rebate account.

19. The method of claim 11, wherein the property is one of a real property and a car.

20. The method of claim 11, wherein the property is one of an apartment, a condo, and a house.
